(19) United States
(12) Patent Application Publication
(10) Pub. No.: US 2021/0064109 A1
(43) Pub. Date: Mar. 4, 2021

(54) USING A SUPPLEMENTAL POWER SOURCE TO PROVIDE TEMPORARY PERFORMANCE BOOSTS IN COMPUTING DEVICES

(71) Applicant: Microsoft Technology Licensing, LLC, Redmond, WA (US)

(72) Inventors: Prateek TANDON, Issaquah, WA (US); Brian Jacob CORELL, Sammamish, WA (US)

(21) Appl. No.: 16/556,194

(22) Filed: Aug. 29, 2019

(51) Int. Cl. G06F 1/28; G06F 1/26; G06F 11/30

(52) U.S. Cl. CPC G06F 1/28; G06F 11/3062; G06F 1/263

(57) ABSTRACT

A supplemental power source may be used to provide temporary performance boosts in a computing device by providing additional power to supplement a primary power source. The supplemental power can be used, for example, to run components of a computer system (e.g., a CPU, GPU, memory, SSD, FPGA, and/or ASIC) at higher power to improve performance. In some embodiments, the supplemental power manager may invoke supplemental power from the supplemental power source whenever it determines that an application on the computing device can benefit from additional power and the operating power that is being supplied by the primary power source is at its maximum level. In some embodiments, a determination may be made that an application can benefit from additional power if the application is principally limited by the performance of a particular hardware component and additional power could improve the performance of that hardware component.

### CROSS-REFERENCE TO RELATED APPLICATIONS

N/A

### BACKGROUND

A data center is a physical facility that is used to house computer systems and associated components. A data center typically includes a large number of servers, which may be placed in racks and arranged in rows. A colocation center is a type of data center where equipment, space, and bandwidth are available for rental to customers.

The electrical infrastructure of a data center may include a power supply system. In this context, the term “power supply system” may refer to one or more components that provide a source of power to at least some of the servers and/or other components in the data center. For example, a power supply system may include a connection to the main power grid, which is typically provided by the local utility company. The electricity from the local utility company is typically delivered with a medium voltage. A power supply system may include one or more transformers that transform the medium-voltage electricity to low voltage for use within the data center. One or more uninterrupted power supply (UPS) systems and one or more power distribution units (PDUs) may be included within a power supply system for distributing low-voltage electricity to server racks and other endpoints.

The components in a data center's power supply system typically have a power rating. Power ratings are usually set as guidelines by manufacturers. In components that primarily convert between different forms of electrical power (e.g., transformers) or transport power from one location to another (e.g., PDUs), the power rating associated with a particular component typically indicates an amount of power that can be permitted to flow through that component without damaging the component. Power ratings generally include a certain safety margin. Exceeding the power rating of a component by a small amount (within the safety margin set by the manufacturer) for a very short period of time is generally not harmful. However, exceeding the power rating of a component by more than the safety margin may damage the component by causing its operating temperature to exceed safe levels.

There are generally restrictions on the amount of instantaneous power that a server rack is permitted to draw from a data center's power supply system. In some data centers, there may be a maximum power level that is defined for each server rack. This maximum power level may be defined based on the power ratings of the components in the power supply system. The maximum power level for a particular server rack may indicate an amount of power that can be safely provided to the server rack by the data center's power supply system without damaging system components. If the amount of power that is drawn by a server rack exceeds this maximum power level, this may cause one or more components within the data center's power supply system to shut down. Generally speaking, the components within a data center's power supply system are designed so that their power ratings are significantly higher than the amount of power that is expected to be used by servers during actual operation. Therefore, under normal circumstances, the amount of power that is drawn by a server rack should not exceed the maximum power level that has been defined for that server rack.

In some data centers, the servers may each be equipped with a rechargeable battery. The battery within a server may be used to preserve data in the event of a power or hardware failure. For example, when one or more components within a data center's electrical infrastructure fails and stops supplying power to a server, the battery within the server may be used to keep the server powered up while vital data from the central processing unit (CPU) and memory subsystem can be drained to persistent storage.

### SUMMARY

In accordance with one aspect of the present disclosure, a computer-implemented method is disclosed that includes identifying an application running on a computing device that can benefit from additional power. If a determination is made that operating power that is being supplied to the computing device by a primary power source is at a maximum power level, a supplemental power manager causes a supplemental power source to provide supplemental power to the computing device. The supplemental power is provided in addition to the operating power that is supplied by the primary power source.

In some embodiments, the computing device may include a server in a data center. The primary power source may include a power supply system of the data center.

Identifying the application that can benefit from the additional power may include determining that performance of the application is principally limited by a hardware component of the computing device and determining that the supplemental power could improve a performance level of the hardware component.

The hardware component may be selected from the group consisting of a central processing unit (CPU), a graphics processing unit (GPU), memory, a solid-state drive (SSD), a field programmable gate array (FPGA), and an application specific integrated circuit (ASIC).

The supplemental power may be directed to a specific hardware component within the computing device. Causing the supplemental power to be directed to the specific hardware component may include causing a power threshold associated with the specific hardware component to be increased.

The supplemental power manager may be configured to cause the supplemental power source to discontinue providing the supplemental power to the computing device in response to determining that the application can no longer benefit from the supplemental power.

In some embodiments, the supplemental power manager may prevent the supplemental power from being utilized by components in the computing device other than an intended hardware component.

The supplemental power manager may cause the supplemental power to be directed to a cooling fan within the computing device.

In some embodiments, the supplemental power manager may be configured to save a history of state variables corresponding to periods of time when the supplemental power is used and predicting when the supplemental power is beneficial based on the history.

In accordance with another aspect of the present disclosure, a computing device is disclosed that includes a connection to a primary power source, a supplemental power source, one or more processors, memory in electronic communication with the one or more processors, and instructions stored in the memory. The instructions are executable by the one or more processors to identify an application running on the computing device whose performance is principally limited by a hardware component of the computing device. The instructions are additionally executable to determine that additional power could improve a performance level of the hardware component, determine that operating power that is being supplied to the computing device by the primary power source is at a maximum power level, and cause the supplemental power source to provide supplemental power to the computing device. The supplemental power is provided in addition to the operating power that is supplied by the primary power source.

The supplemental power source may be selected from the group consisting of a rechargeable battery and a supercapacitor.

The computing device may further include additional instructions that are executable by the one or more processors to cause the supplemental power to be directed to a specific hardware component within the computing device.

In some embodiments, causing the supplemental power to be directed to the specific hardware component may include causing a power threshold associated with the specific hardware component to be increased.

The computing device may further include additional instructions that are executable by the one or more processors to cause the supplemental power to be directed to a cooling fan within the computing device.

The computing device may further include additional instructions that are executable by the one or more processors to cause the supplemental power source to discontinue providing the supplemental power to the computing device in response to determining that the performance of the application is no longer principally limited by the hardware component or that the performance level of the hardware component is at a maximum performance level.

The computing device may further include one or more microelectromechanical systems (MEMS)-based energy harvesters and circuitry that extracts energy from the MEMS-based energy harvesters and provides the energy to the supplemental power source.

In accordance with another aspect of the present disclosure, a computer-readable medium includes instructions that are executable by one or more processors to cause a computing device to monitor power usage of the computing device. A primary power source supplies operating power to the computing device. The instructions also detect that the power usage of the computing device is above a maximum power level that has been defined for the computing device based on capabilities of the primary power source and cause a supplemental power source to provide supplemental power to the computing device. The supplemental power is provided in addition to the operating power that is supplied by the primary power source.

The computing device may include a server in a data center and the primary power source may include a power supply system of the data center.

The computer-readable medium may further include additional instructions that are executable by the one or more processors to cause the supplemental power source to discontinue providing the supplemental power to the computing device in response to determining that the power usage of the computing device has fallen below the maximum power level that has been defined for the computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example of a system in which the techniques disclosed herein may be utilized, including a computing device that draws its operating power from a primary power source and that also includes a supplemental power source.

FIG. 2 illustrates an example of a method that may be implemented by a supplemental power manager in the computing device shown in FIG. 1.

FIG. 3 illustrates another example of a system in which the techniques disclosed herein may be utilized, including a supplemental power manager that is configured to determine whether an application is principally limited by the performance of a particular hardware component.

FIG. 4 illustrates an example of a method that may be implemented by the supplemental power manager in the computing device shown in FIG. 3, including determining whether an application can benefit from additional power.

FIG. 5 illustrates another example of a method that may be implemented by the supplemental power manager in the computing device shown in FIG. 3, including invoking supplemental power when a temperature threshold is exceeded.

FIG. 6 illustrates an example of a system in which a supplemental power manager causes supplemental power to be directed to a specific hardware component by causing a power threshold associated with the specific hardware component to be increased.

FIG. 7 illustrates an example of a system in which a supplemental power manager enables supplemental power to be utilized by a particular hardware component by preventing the supplemental power from reaching other components.

FIG. 8 illustrates an example of a method that may be implemented by the supplemental power manager in the computing device shown in FIG. 7, including sending to power regulators in the computing device.

FIG. 9 illustrates an example of a system that includes a supplemental power manager as well as a plurality of microelectromechanical systems (MEMS)-based energy harvesters.

FIG. 10 illustrates an example of a system in which a supplemental power manager invokes supplemental power from a supplemental power source whenever it determines that the power usage of the computing device is above a defined maximum power level.

FIG. 11 illustrates an example showing a defined maximum power level for a computing device compared to the power consumption of the computing device over time.

FIG. 12 illustrates an example of a method that may be implemented by the supplemental power manager in the computing device shown in FIG. 10, including invoking supplemental power when the power usage of the computing device exceeds the maximum power level.

FIG. 13 illustrates an example of a data center that includes a plurality of server racks, wherein each server includes a supplemental power source and a supplemental power manager.

FIG. 14 illustrates certain components that may be included within a computing device.

### DETAILED DESCRIPTION

The present disclosure is generally related to using a supplemental power source (e.g., a battery) in high-performance computer systems to provide temporary performance boosts by providing extra power to supplement traditional power supplies. The extra power can be used, for example, to run components of a computer system at higher power to improve performance. The supplemental power may be provided on a temporary (as needed) basis, and discontinued when it is no longer beneficial. Some examples of components to which extra power can be provided include central processing units (CPUs), graphics processing units (GPUs), memory (including volatile memory as well as non-volatile memory devices such as non-volatile dual in-line memory modules (NVDIMMs)), solid-state drives (SSDs), and hardware accelerators such as field programmable gate arrays (FPGAs) and application specific integrated circuits (ASICs).

The techniques disclosed herein may be implemented in connection with a computing device (e.g., a server in a data center) that draws its operating power from a primary power source (e.g., a data center's power supply system) and that also includes a supplemental power source (e.g., a rechargeable battery). A supplemental power manager may be configured to monitor the performance of one or more applications running on the computing device. In some embodiments, the supplemental power manager may be some type of software (e.g., a program, a utility) that is configured to invoke supplemental power from the supplemental power source under certain circumstances.

In some embodiments, the supplemental power manager may invoke supplemental power from the supplemental power source whenever it determines that (i) an application on the computing device can benefit from additional power, and (ii) the operating power that is being supplied by the primary power source is at its maximum level, and therefore is unable to provide any additional power without potentially causing problems with respect to the primary power source. In other words, the supplemental power manager may cause the supplemental power source to supply supplemental power (i.e., power in addition to the power that is being provided by the primary power source) to the computing device whenever a determination is made that conditions (i) and (ii) are true.

The supplemental power may be provided in addition to the normal operating power that is being provided by the computing device's primary power source. For example, in the case of a server in a data center, the supplemental power manager may cause the supplemental power source to provide supplemental power to the server in addition to the normal operating power that is being provided by the data center's power supply system.

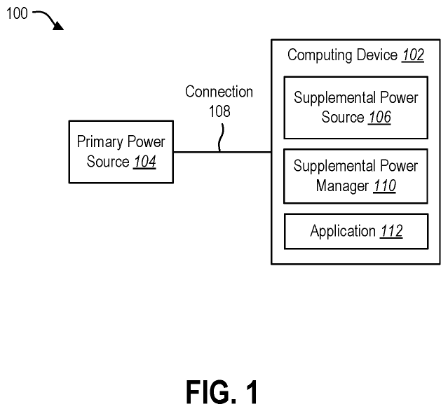

FIG. 1 illustrates an example of a system 100 in which the techniques disclosed herein may be utilized. The system 100 includes a computing device 102 that draws its operating power from a primary power source 104 and that also includes a supplemental power source 106. The computing device 102 may be, for example, a server in a data center, and the primary power source 104 may be the data center's power supply system. The computing device 102 is shown with a connection 108 to the primary power source 104. In some embodiments, the supplemental power source 106 may be a rechargeable battery. In other embodiments, the supplemental power source 106 may be another type of replenishable power source such as a supercapacitor.

A supplemental power manager 110 is running on the computing device 102. The supplemental power manager 110 may be configured to invoke supplemental power from the supplemental power source 106 under certain circumstances. The supplemental power may be provided in addition to the normal operating power that is being provided by the primary power source 104 of the computing device 102.

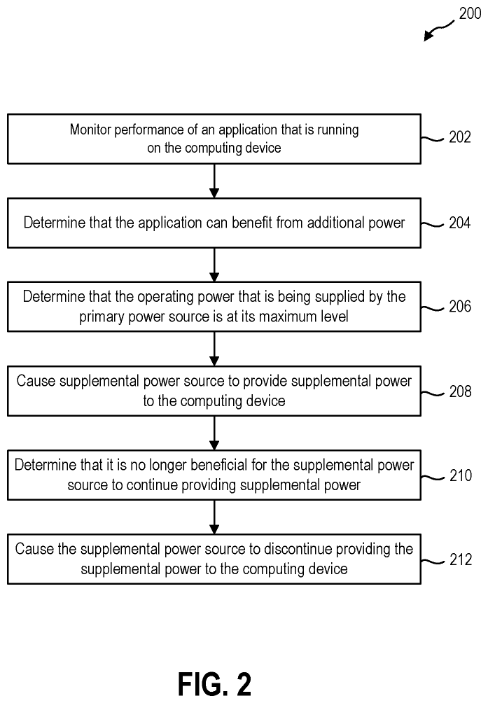

FIG. 2 illustrates an example of a method 200 that may be implemented by the supplemental power manager 110 in the computing device 102 shown in FIG. 1. In accordance with the method 200, the supplemental power manager 110 may monitor 202 the performance of an application 112 that is running on the computing device 102.

At some point, the supplemental power manager 110 may determine 204 that the application 112 can benefit from additional power. In other words, the supplemental power manager 110 may determine 204 that the performance of the application 112 could be enhanced if additional power were provided to the computing device 102. Some examples of how the supplemental power manager 110 may make this determination will be discussed below.

The supplemental power manager 110 may also determine 206 that the operating power that is being supplied by the primary power source 104 is at its maximum level. In other words, the supplemental power manager 110 may determine 206 that the primary power source 104 cannot provide any additional power to the computing device 102 without potentially causing problems (e.g., the failure of one or more components of the primary power source 104). In embodiments where the computing device 102 is a server in a data center, the supplemental power manager 110 may determine 206 that the server is already drawing power at a maximum power level that has been defined for the server, and that drawing additional power from the data center's power supply system could potentially damage one or more components within the data center's power supply system.

In response to determining 204 that the performance of the application 112 could be enhanced if additional power were provided to the computing device 102 and also determining 206 that the operating power that is being supplied by the primary power source 104 is at its maximum level, the supplemental power manager 110 may cause the supplemental power source 106 to provide supplemental power to the computing device 102. The supplemental power may be provided in addition to the normal operating power that is being provided by the primary power source 104.

At some point after the supplemental power manager 110 causes 208 the supplemental power source 106 to provide supplemental power to the computing device 102, the supplemental power manager 110 may determine 210 that it is no longer beneficial for the supplemental power source 106 to continue providing supplemental power to the computing device 102. In other words, it may be determined 210 that the application 112 is no longer benefitting from the supplemental power. In response to making this determination, the supplemental power manager 110 may cause 212 the supplemental power source 106 to discontinue providing the supplemental power to the computing device 102.

As indicated above, one of the factors that may cause a supplemental power manager to invoke supplemental power from a supplemental power source is a determination that an application on the computing device can benefit from additional power. Some examples of how this determination may be made will now be described.

The performance of an application may be limited by one or more hardware components of a computing device. The term “bound” is often used in connection with a specific hardware component to indicate when an application is being limited in this way. For example, an application may be referred to as being “CPU bound” if the performance of an application is limited principally by the speed of the CPU. An application may be referred to as being “GPU bound” if the performance of an application is limited principally by the speed of the GPU. An application may be referred to as being “memory bound” if the performance of an application is limited principally by the speed of access to data stored in memory. There are various performance analysis tools that may be used to determine whether an application is CPU bound, GPU bound, or memory bound. Performance analysis tools may also be used to determine whether an application is limited by the performance of other components of a computer system, such as SSDs, FPGAs, ASICs, and the like. Some examples of performance analysis tools that are currently in use with respect to CPU and memory include perf, VTune, OProfile, and dstat. An example of a performance analysis tool that is currently in use for GPUs made by Nvidia Corporation is nvprof. Of course, these particular performance analysis tools are examples only and should not be interpreted as limiting the scope of the present disclosure. In some embodiments, instead of using an existing performance analysis tool, a new performance analysis tool may be created to provide the desired information, which is generally determined by reading performance counters. Alternatively, an existing performance analysis tool may be modified to provide the desired information.

In some embodiments, a determination may be made that an application running on a computing device can benefit from additional power if (a) the application is principally limited by the performance of a particular hardware component, and (b) additional power could improve the performance of that hardware component. For example, if a determination is made that an application is CPU bound and that additional power could improve the performance of the CPU, then it may be concluded that the application can benefit from additional power. Similar determinations may be made with respect to other types of hardware components, such as GPUs, memory, SSDs, FPGAs, ASICs, and the like.

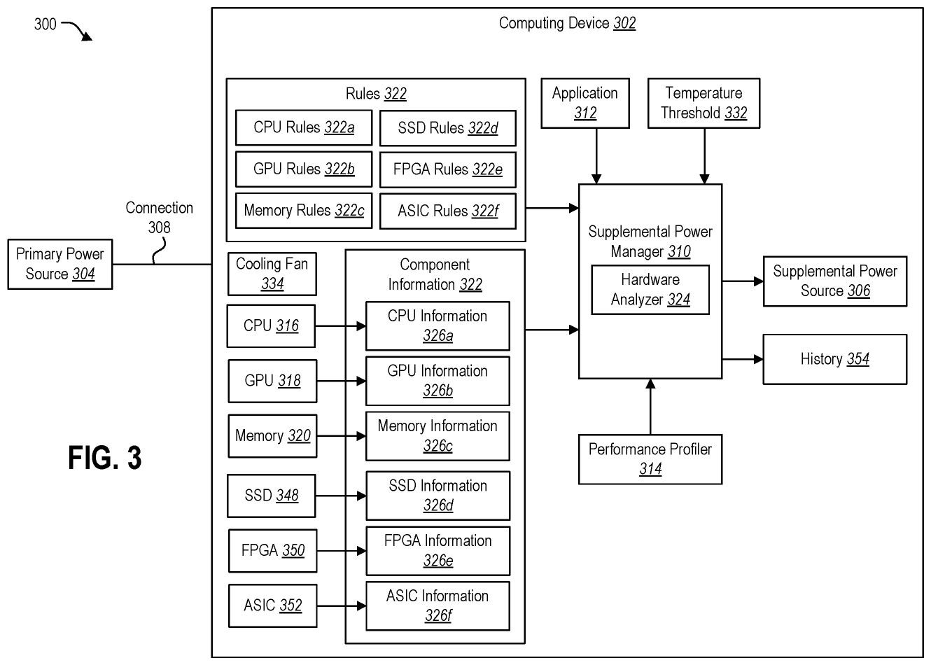

FIG. 3 illustrates another example of a system 300 in which the techniques disclosed herein may be utilized. The system 300 includes a computing device 302 that draws its operating power from a primary power source 304 and that also includes a supplemental power source 306. The computing device 302 is shown with a connection 308 to the primary power source 304. A supplemental power manager 310 on the computing device 302 may invoke supplemental power from the supplemental power source 306 when the supplemental power manager 310 determines that an application 312 on the computing device 302 can benefit from additional power.

In the depicted example, the supplemental power manager 310 is configured to determine whether the application 312 is principally limited by the performance of a particular hardware component. If so, then the supplemental power manager 310 may also determine whether additional power could improve the performance of that hardware component. For purposes of example, several of the hardware components in the computing device 302 are shown in FIG. 3, including the CPU 316, GPU 318, memory 320, SSD 348, FPGA 350, and ASIC 352.

To determine whether the application 312 is principally limited by the performance of a particular hardware component, the supplemental power manager 310 may utilize a software utility that may be referred to herein as a performance profiler 314 (or alternatively as a performance analysis tool). The performance profiler 314 may be configured to determine whether the application 312 is principally limited by the performance of a particular hardware component (e.g., CPU 316, GPU 318, memory 320, SSD 348, FPGA 350, ASIC 352), and to provide this information to the supplemental power manager 310.

If the performance profiler 314 notifies the supplemental power manager 310 that the application 312 is principally limited by the performance of a particular hardware component, the supplemental power manager 310 may, in response, determine whether additional power could improve the performance of that hardware component. The supplemental power manager 310 is shown with a hardware analyzer 324 for providing this functionality. For example, suppose that the performance profiler 314 notifies the supplemental power manager 310 that the application 312 is CPU bound. In response, the hardware analyzer 324 may determine whether additional power could improve the performance of the CPU 316.

Various rules 322 may be defined that indicate when a particular hardware component can benefit from additional power. In the depicted example, the rules 322 include CPU rules 322a that indicate when the CPU 316 can benefit from additional power, GPU rules 322b that indicate when the GPU 318 can benefit from additional power, memory rules 322c that indicate when the memory 320 can benefit from additional power, SSD rules 322d that indicate when the SSD 348 can benefit from additional power, FPGA rules 322e that indicate when the FPGA 350 can benefit from additional power, and ASIC rules 322f that indicate when the ASIC 352 can benefit from additional power. The hardware analyzer 324 may take these rules 322 into consideration when determining whether additional power could improve the performance of a hardware component.

The hardware analyzer 324 may also take into consideration information 326 about current characteristics of various hardware components in the computing device 302. For example, when determining whether the CPU 316 can benefit from additional power, the hardware analyzer 324 may take into consideration information 326a about current characteristics of the CPU 316. The hardware analyzer 324 may take into consideration similar information (e.g., GPU information 326b, memory information 326c, SSD information 326d, FPGA information 326e, ASIC information 3260 about current characteristics of other hardware components (e.g., the GPU 318, memory 320, SSD 348, FPGA 350, and ASIC 352).

In some embodiments, the supplemental power manager 310 may save a history 354 of various state variables when extra power is used. This history 354 can then be used to predict when the use of supplemental power would be beneficial. For example, over time the history 354 could be used to identify one or more characteristics of particular state variables (e.g., instructions being executed, power levels) when supplemental power is invoked. When current values of these state variables match the values when supplemental power has been invoked in the past, a prediction can be made about whether supplemental power would be beneficial. To alleviate privacy concerns, this could be a non-invasive process and an opt-in feature for users.

Next, a description will be provided about various ways to determine whether additional power can potentially improve the performance of particular hardware components. The CPU will be discussed initially.

Determining whether additional power could improve the performance of a CPU may involve determining whether the CPU is operating at its maximum performance level. If the CPU is not operating at its maximum performance level, then the performance of the CPU could potentially be improved by increasing power to the CPU.

There are several different ways that the maximum performance level of a CPU may be defined. In some embodiments, the maximum performance level of a CPU may be defined in terms of the frequency at which the CPU is running.

A CPU's clock signal is produced by an oscillator circuit that generates a consistent number of pulses each second in the form of a periodic square wave. The frequency of the clock pulses determines the rate at which a CPU executes instructions. Generally speaking, increasing the frequency of the clock pulses increases the number of instructions the CPU executes each second. A CPU manufacturer generally provides a default frequency for a CPU (e.g., 3 GHz). This may also be referred to as the CPU speed. However, it may be possible to operate the CPU at a higher frequency without degrading the CPU's performance, because CPU manufacturers typically set the default frequency well below the actual maximum frequency at which the CPU can safely operate.

In some embodiments, determining whether a CPU is operating at its maximum performance level may involve determining whether the CPU is operating below the default frequency provided by the CPU manufacturer. In such embodiments, if a determination is made that the CPU is operating below the default frequency provided by the CPU manufacturer, then it may be concluded that the CPU is operating below its maximum performance level and that additional power could potentially improve the CPU's performance.

In some embodiments, determining whether the CPU is operating at its maximum performance level may involve determining whether the CPU is operating below the actual maximum frequency at which the CPU can safely operate. In such embodiments, if a determination is made that the CPU is operating below the actual maximum frequency at which the CPU can safely operate (even if the CPU is operating at or above the default frequency provided by the manufacturer), then it may be concluded that the CPU is operating below its maximum performance level and that additional power could potentially improve the CPU's performance.

Some CPUs are configured with a “turbo” mode that accelerates processor performance for peak loads, automatically allowing processor cores to run faster than the rated operating frequency if they are operating below power, current, and temperature specification limits. In embodiments where these kinds of CPUs are in use, determining whether the CPU is operating at its maximum performance level may involve determining whether the CPU is operating below the maximum frequency at which the CPU can safely operate while in turbo mode.

In some embodiments, the maximum performance level of a CPU may be defined in terms of the temperature at which the CPU is operating. There is a maximum temperature for a CPU above which the CPU's performance will become degraded and potentially damage the CPU. This maximum temperature may be referred to herein as the CPU's thermal limit. In some embodiments, determining whether the CPU is operating at its maximum performance level may involve determining whether the CPU is operating below its thermal limit. In such embodiments, if a determination is made that the CPU is operating below its thermal limit, then it may be concluded that the CPU is operating below its maximum performance level and that additional power could potentially improve the CPU's performance.

Determining whether additional power could improve the performance of a GPU may involve considerations that are similar to those discussed above in connection with a CPU. For example, determining whether additional power could improve the performance of a GPU may involve determining whether the GPU is operating at its maximum performance level. If the GPU is not operating at its maximum performance level, then the performance of the GPU could potentially be improved by increasing power to the GPU.

As with a CPU, there are several different ways that the maximum performance level of a GPU may be defined. For instance, the maximum performance level of a GPU may be defined in terms of the frequency at which the GPU is running.

In some embodiments, determining whether a GPU is operating at its maximum performance level may involve determining whether the GPU is operating below the default frequency provided by the GPU manufacturer. In such embodiments, if a determination is made that the GPU is operating below the default frequency provided by the GPU manufacturer, then it may be concluded that the GPU is operating below its maximum performance level and that additional power could potentially improve the GPU's performance.

In some embodiments, determining whether the GPU is operating at its maximum performance level may involve determining whether the GPU is operating below the actual maximum frequency at which the GPU can safely operate. In such embodiments, if a determination is made that the GPU is operating below the actual maximum frequency at which the GPU can safely operate (even if the GPU is operating at or above the default frequency provided by the manufacturer), then it may be concluded that the GPU is operating below its maximum performance level and that additional power could potentially improve the GPU's performance.

In some embodiments, the maximum performance level of a GPU may be defined in terms of the temperature at which the GPU is operating. As with a CPU, there is a maximum temperature for a GPU above which the GPU's performance will become degraded and potentially damage the GPU. This maximum temperature may be referred to herein as the GPU's thermal limit. In some embodiments, determining whether the GPU is operating at its maximum performance level may involve determining whether the GPU is operating below its thermal limit. In such embodiments, if a determination is made that the GPU is operating below its thermal limit, then it may be concluded that the GPU is operating below its maximum performance level and that additional power could potentially improve the GPU's performance.

If a performance profiler determines that a CPU is stalled on memory, it can be inferred that memory is the limiting factor. In response to making such a determination, additional power can be added to the memory (e.g., by providing additional voltage) in order to gain performance. In some embodiments, a limit may be defined above which additional power should not be provided, either because the additional power will not be likely to improve memory performance or even potentially damage the memory. Vendors of memory (and other hardware components) often provide information about such limits. For memory/persistent memory, vendors typically list the bandwidth/latency for different power levels. These values can be used as a guide to determine whether additional power should be provided.

As discussed above, if a supplemental power manager determines that (i) an application on the computing device can benefit from additional power, and (ii) the operating power that is being supplied by the primary power source is at its maximum level, then the supplemental power manager may cause the supplemental power source to provide supplemental power to the computing device.

Moreover, regarding condition (i), a determination may be made that an application running on a computing device can benefit from additional power if (a) the application is principally limited by the performance of a particular hardware component, and (b) additional power could improve the performance of that hardware component.

Thus, in some embodiments, a supplemental power manager may cause a supplemental power source to provide supplemental power to a computing device if the supplemental power manager determines that (i)(a) an application running on a computing device is principally limited by the performance of a particular hardware component, (i)(b) additional power could improve the performance of that hardware component, and (ii) the operating power that is being supplied by the computing device's primary power source is at its maximum level and cannot provide any additional power.

Moreover, in some embodiments, the supplemental power manager may be configured to cause at least some of the supplemental power to be directed to a specific hardware component (e.g., the hardware component that is the subject of conditions (i)(a) and (i)(b)). In other words, in accordance with the techniques disclosed herein, power may be dynamically allocated to different components. For example, if the supplemental power manager determines that (i)(a) the application is CPU bound, (i)(b) additional power could improve the CPU's performance, and (ii) the computing device's primary power source is unable to supply the additional power, the supplemental power manager may cause the supplemental power source to provide supplemental power to the computing device and also direct at least some of that supplemental power to the CPU. Directing supplemental power to a particular hardware component may cause that hardware component to run at a higher level.

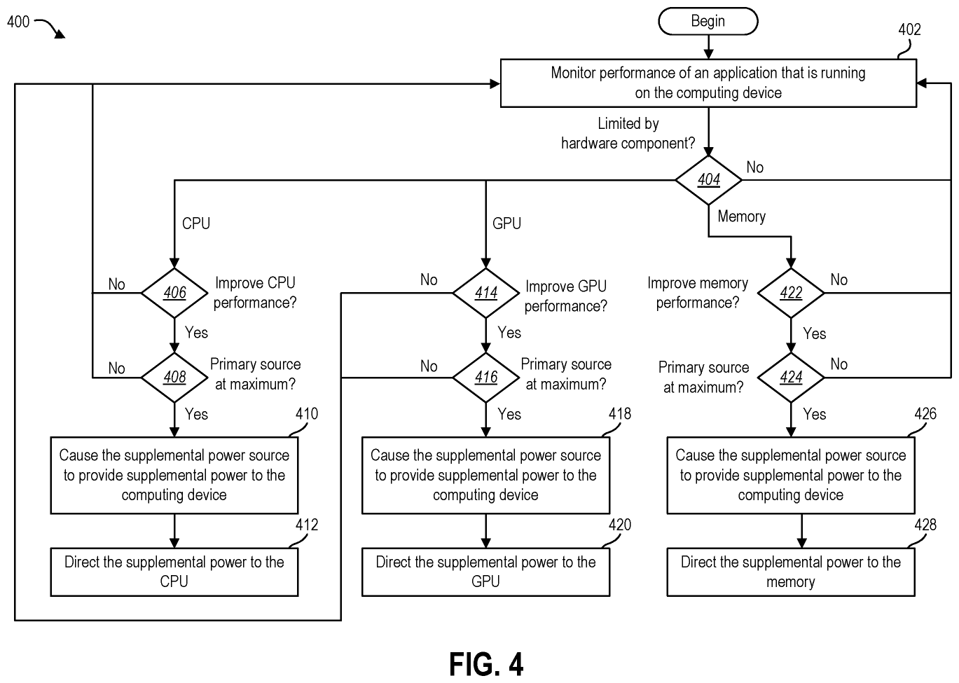

FIG. 4 illustrates an example of a method 400 that may be implemented by a supplemental power manager in accordance with the present disclosure. The method 400 will be described in relation to the supplemental power manager 310 and the other components in the system 300 shown in FIG. 3.

In accordance with the method 400, the supplemental power manager 310 may monitor 402 the performance of an application 312 that is running on the computing device 302. As part of monitoring 402 the performance of the application 312, the supplemental power manager 310 may determine 404 whether the application 112 is principally limited (or bound) by the performance of a particular hardware component, such as the CPU 316, GPU 318, memory 320, SSD 348, FPGA 350, or ASIC 352. The supplemental power manager 310 may utilize a performance profiler 314 to make this determination. In some embodiments, this determination may be made on a periodic basis.

If the supplemental power manager 310 determines 404 that the application 312 is not principally limited by the performance of any particular hardware component, then the method 400 returns to the point where the supplemental power manager 310 monitors 402 the performance of the application 312. In embodiments where the supplemental power manager 310 periodically determines 404 whether the application 112 is principally limited by the performance of a particular hardware component, the supplemental power manager 310 may continue to monitor the performance of the application 312 until it is once again time to determine 404 whether the application 112 is principally limited by the performance of a particular hardware component.

If the supplemental power manager 310 determines 404 that the application 312 is principally limited by the performance of the CPU 316 (or, in other words, that the application 312 is CPU bound), then the supplemental power manager 310 may determine 406 whether additional power could improve the performance of the CPU 316. In making this determination, the supplemental power manager 310 may take into consideration CPU rules 322a that have been defined to indicate when the CPU 316 can benefit from additional power and/or information 326a about current characteristics of the CPU 316.

If the supplemental power manager 310 determines 406 that additional power would not improve the performance of the CPU 316, then the method 400 returns to the point where the supplemental power manager 310 monitors 402 the performance of the application 312. If, however, the supplemental power manager 310 determines 406 that additional power would improve (or would be likely to improve) the performance of the CPU 316, then the supplemental power manager 310 may determine 408 whether the operating power that is being supplied by the primary power source 304 of the computing device 302 is at its maximum level. In other words, the supplemental power manager 310 may determine 408 whether the primary power source 304 is able to provide additional power. If the supplemental power manager 310 determines 408 that the operating power that is being supplied by the primary power source 304 of the computing device 302 is not at its maximum level, then it may not be necessary for the supplemental power source 306 to provide supplemental power, and the method 400 may simply return to the point where the supplemental power manager 310 monitors 402 the performance of the application 312. If, however, the supplemental power manager 310 determines 408 that the operating power that is being supplied by the primary power source 304 of the computing device 302 is at its maximum level, then the supplemental power manager 310 may cause 410 the supplemental power source 306 to provide supplemental power to the computing device 302 and direct 412 at least some of the supplemental power to the CPU 316 so that the CPU 316 runs at a higher power level.

If the supplemental power manager 310 determines 404 that the application 312 is principally limited by the performance of the GPU 318 (or, in other words, that the application 312 is GPU bound), then the supplemental power manager 310 may determine 414 whether additional power could improve the performance of the GPU 318. In making this determination, the supplemental power manager 310 may take into consideration GPU rules 322b that have been defined to indicate when the GPU 318 can benefit from additional power and/or information 326b about current characteristics of the GPU 318.

If the supplemental power manager 310 determines 414 that additional power would not improve the performance of the GPU 318, then the method 400 returns to the point where the supplemental power manager 310 monitors 402 the performance of the application 312. If, however, the supplemental power manager 310 determines 414 that additional power would improve (or would be likely to improve) the performance of the GPU 318, then the supplemental power manager 310 may determine 416 whether the operating power that is being supplied by the primary power source 304 of the computing device 302 is at its maximum level. If not, then it may not be necessary for the supplemental power source 306 to provide supplemental power, and the method 400 may simply return to the point where the supplemental power manager 310 monitors 402 the performance of the application 312. If, however, the supplemental power manager 310 determines 416 that the operating power that is being supplied by the primary power source 304 of the computing device 302 is at its maximum level, then the supplemental power manager 310 may cause 418 the supplemental power source 306 to provide supplemental power to the computing device 302 and direct 420 at least some of the supplemental power to the GPU 318 so that the GPU 318 runs at a higher power level.

If the supplemental power manager 310 determines 404 that the application 312 is principally limited by the performance of the memory 320 (or, in other words, that the application 312 is memory bound), then the supplemental power manager 310 may determine 422 whether additional power could improve the performance of the memory 320. In making this determination, the supplemental power manager 310 may take into consideration memory rules 322c that have been defined to indicate when the memory 320 can benefit from additional power and/or information 326c about current characteristics of the memory 320.

If the supplemental power manager 310 determines 422 that additional power would not improve the performance of the memory 320, then the method 400 returns to the point where the supplemental power manager 310 monitors 402 the performance of the application 312. If, however, the supplemental power manager 310 determines 422 that additional power would improve (or would be likely to improve) the performance of the memory 320, then the supplemental power manager 310 may determine 424 whether the operating power that is being supplied by the primary power source 304 of the computing device 302 is at its maximum level. If not, then it may not be necessary for the supplemental power source 306 to provide supplemental power, and the method 400 may simply return to the point where the supplemental power manager 310 monitors 402 the performance of the application 312. If, however, the supplemental power manager 310 determines 424 that the operating power that is being supplied by the primary power source 304 of the computing device 302 is at its maximum level, then the supplemental power manager 310 may cause 426 the supplemental power source 306 to provide supplemental power to the computing device 302 and direct 428 at least some of the supplemental power to the memory 320 so that the memory 320 runs at a higher power level.

For purposes of example, the method 400 shown in FIG. 4 includes specific actions that may be taken if the supplemental power manager 310 determines 404 that the application 312 is principally limited by the performance of the CPU 316, GPU 318, or memory 320. Similar actions may be taken if the supplemental power manager 310 determines 404 that the application 312 is principally limited by the performance of another hardware component, such as the SSD 348, FPGA 350, or ASIC 352.

As indicated above, when certain conditions are satisfied, a supplemental power manager may cause a supplemental power source to provide supplemental power to the computing device. Moreover, the supplemental power manager may cause at least some of the supplemental power to be directed to a specific hardware component. In some embodiments, instead of causing the supplemental power to be directed to the specific hardware component that is limiting the performance of the application, the supplemental power manager may instead cause the supplemental power to be directed to another component within the computing device that can improve the performance of the hardware component. For example, the supplemental power manager may cause the supplemental power to be directed to a cooling fan within the computing device. This may have the effect of increasing the speed at which the cooling fan operates, thereby increasing the amount of air circulation within the computing device and lowering the internal temperature of at least some of the hardware components within the computing device. Lowering the temperature of a hardware component can, in some situations, improve the performance of that hardware component. For example, lowering the CPU's temperature may improve the CPU's performance, particularly if the CPU is operating near its thermal limits.

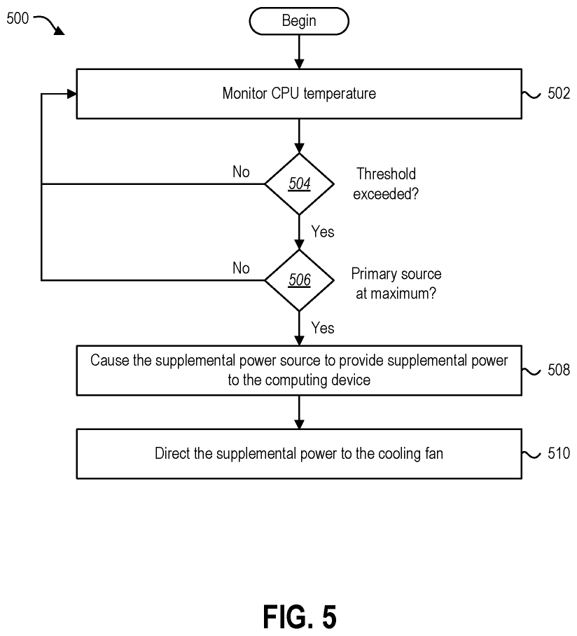

FIG. 5 illustrates another example of a method 500 that may be implemented by a supplemental power manager in accordance with the present disclosure. The method 500 will be described in relation to the supplemental power manager 310 and the other components in the system 300 shown in FIG. 3.

In accordance with the method 500, the supplemental power manager 310 may monitor 502 the temperature of the CPU 316 within the computing device 302. This may involve receiving information from a temperature sensor, which may be coupled to or positioned near the CPU 316.

As part of monitoring 502 the temperature of the CPU 316, the supplemental power manager 310 may determine 504 whether the temperature of the CPU 316 has exceeded a defined threshold value 332. If not, then the method 500 returns to the point where the supplemental power manager 310 monitors 502 the temperature of the CPU 316. In embodiments where the supplemental power manager 310 periodically determines 504 whether the temperature of the CPU 316 has exceeded the threshold value 332, the supplemental power manager 310 may continue to monitor the temperature of the CPU 316 until it is once again time to determine 504 whether the temperature of the CPU 316 has exceeded the threshold value 332.

If the supplemental power manager 310 determines 504 that the temperature of the CPU 316 has exceeded the defined threshold value 332, this indicates that it may be beneficial to increase the speed of a cooling fan 334 within the computing device 302. Increasing the speed of the cooling fan 334 may involve causing the speed of the motor to be increased, so that the blades of the cooling fan 334 rotate faster and create more air circulation. If the cooling fan 334 has not previously been turned on, then increasing the speed of the cooling fan 334 may involve turning on the cooling fan 334.

Because increasing the speed of the cooling fan 334 requires additional power, the supplemental power manager 310 may determine whether the primary power source 304 can provide that additional power, or whether the supplemental power source 306 should begin providing supplemental power. More specifically, the supplemental power manager 310 may determine 506 whether the operating power that is being supplied by the primary power source 304 of the computing device 302 is at its maximum level. In other words, the supplemental power manager 310 may determine 506 whether the primary power source 304 is able to provide any additional power at the present time.

If the supplemental power manager 310 determines 506 that the operating power that is being supplied by the primary power source 304 of the computing device 302 is not at its maximum level, then it may not be necessary for the supplemental power source 306 to provide supplemental power, and the method 500 may simply return to the point where the supplemental power manager 310 monitors 502 the temperature of the CPU 316. If, however, the supplemental power manager 310 determines 506 that the operating power that is being supplied by the primary power source 304 of the computing device 302 is at its maximum level, then the supplemental power manager 310 may cause 508 the supplemental power source 306 to provide supplemental power to the computing device 302 and direct 510 at least some of the supplemental power to the cooling fan 334 so that the speed of the cooling fan 334 can be increased.

As indicated above, when certain conditions are satisfied, a supplemental power manager may cause a supplemental power source to provide supplemental power to the computing device. Moreover, the supplemental power manager may cause at least some of the supplemental power to be directed to a specific hardware component (e.g., a hardware component that is limiting the performance of the application). In some embodiments, causing the supplemental power to be directed to a specific hardware component involves causing a power threshold associated with the specific hardware component to be increased.

In such embodiments, if it is subsequently determined that the application is no longer benefitting from the supplemental power, the supplemental power manager may cause the power threshold to be lowered to its previous value in addition to causing the supplemental power source to discontinue providing supplemental power to the computing device.

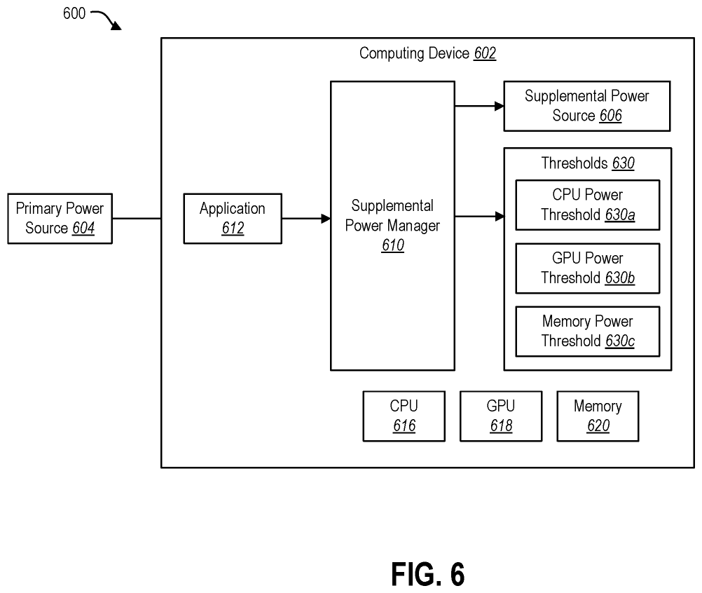

FIG. 6 illustrates an example of a system 600 in which a supplemental power manager 610 in a computing device 602 causes supplemental power from a supplemental power source 606 to be directed to a specific hardware component by causing a power threshold associated with the specific hardware component to be increased.

In the depicted example, there is a specific power threshold 630 associated with at least some of the hardware components of the computing device 602. For example, there is a power threshold 630a associated with the CPU 616, a power threshold 630b associated with the GPU 618, and a power threshold 630c associated with the memory 620. In other examples, additional power thresholds may be associated with other hardware components (e.g., an SSD, an FPGA, an ASIC). These power thresholds 630 may be settings that are initially set by the computing device's basic input/output system (BIOS) when the computing device 602 is initially booted. In some embodiments, the power thresholds 630 may be based on one or more specific programmable locations within the computing device 602. In some embodiments, the power thresholds 630 may be specified by firmware within the computing device 602. In accordance with the techniques disclosed herein, the power thresholds 630 may be dynamically configurable.

If the supplemental power manager 610 determines that certain conditions are satisfied (e.g., an application 612 running on the computing device 602 is principally limited by the performance of a particular hardware component, additional power could improve the performance of that hardware component, and the operating power that is being supplied by the primary power source 604 of the computing device 602 is at its maximum level), the supplemental power manager 610 may cause a supplemental power source 606 to provide supplemental power to the computing device 602. In addition, the supplemental power manager 610 may cause at least some of the supplemental power that is provided by the supplemental power source 606 to be directed to a specific hardware component (e.g., the hardware component that is limiting the performance of the application 612). In the depicted example, the supplemental power manager 610 may cause at least some of the supplemental power that is provided by the supplemental power source 606 to be directed to a specific hardware component by causing the power threshold that is associated with that hardware component to be increased.

If the supplemental power manager 610 subsequently determines that the application 612 is no longer benefitting from the supplemental power, the supplemental power manager 610 may cause the supplemental power source 606 to discontinue providing the supplemental power. The supplemental power manager 610 may also lower the power threshold back to its previous value.

For example, suppose that the supplemental power manager 610 determines that the application 612 is CPU bound, additional power could improve the performance of the CPU 616, and the operating power that is being supplied by the primary power source 604 of the computing device 602 is at its maximum level. In this case, in addition to causing the supplemental power source 606 to provide supplemental power to the computing device 602, the supplemental power manager 610 may also cause the CPU power threshold 630a to be increased.

If the supplemental power manager 610 subsequently determines that the application 612 is no longer benefitting from the supplemental power, the supplemental power manager 610 may cause the supplemental power source 606 to discontinue providing supplemental power to the computing device 602. In addition, the supplemental power manager 610 may cause the CPU power threshold 630a to be lowered to its previous value.

Similar techniques may be utilized to cause supplemental power to be directed to other hardware components, such as the GPU 618, the memory 620, and/or other hardware components (e.g., an SSD, an FPGA, an ASIC). For example, in order to cause supplemental power to be directed to the GPU 618, the supplemental power manager 610 may cause the GPU power threshold 630b to be increased. In order to cause supplemental power to be directed to the memory 620, the supplemental power manager 610 may cause the memory power threshold 630c to be increased. These power thresholds 630b-c may be lowered when the supplemental power is discontinued.

In some embodiments, instead of directly causing supplemental power to be directed to a specific hardware component (e.g., by dynamically allocating power to different components), the supplemental power manager may enable the supplemental power to be utilized by a particular hardware component by preventing the supplemental power from reaching components in the computing device other than an intended component. In such embodiments, one or more power regulators may be provided between the supplemental power source and various components within the computing device. If the supplemental power manager determines that the supplemental power should be utilized by a particular component (e.g., the CPU), the supplemental power manager may cause power regulator(s) between the supplemental power source and one or more other components (e.g., memory) to prevent the supplemental power from being utilized by those other components.

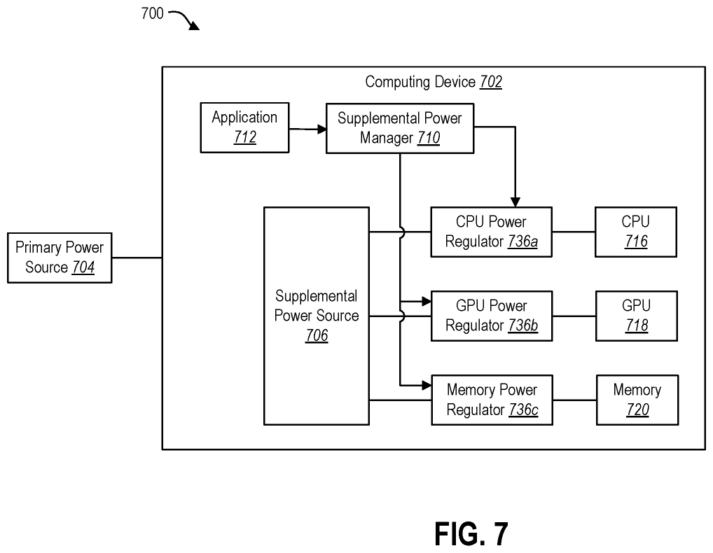

FIG. 7 illustrates an example of a system 700 in which a supplemental power manager 710 in a computing device 702 enables supplemental power to be utilized by a particular hardware component by preventing the supplemental power from reaching other components.

In the depicted system 700, power regulators are provided between the supplemental power source 706 and various components within the computing device 702. In particular, a power regulator 736a is provided between the supplemental power source 706 and the CPU 716 of the computing device 702. Another power regulator 736b is provided between the supplemental power source 706 and the GPU 718 of the computing device 702. Another power regulator 736c is provided between the supplemental power source 706 and the memory 720 of the computing device 702. In other examples, one or more power regulators may be provided between the supplemental power source 706 and various other components, such as an SSD, an FGPA, and/or an ASIC.

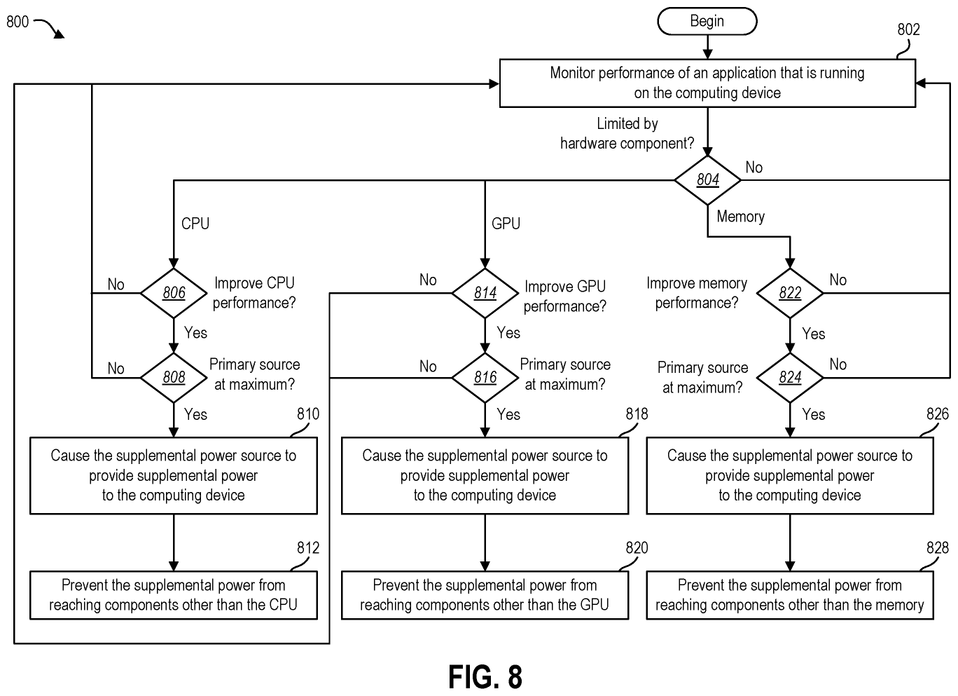

FIG. 8 illustrates another example of a method 800 that may be implemented by a supplemental power manager in accordance with the present disclosure. The method 800 will be described in relation to the supplemental power manager 710 and the other components in the system 700 shown in FIG. 7.

In accordance with the method 800, the supplemental power manager 710 may monitor 802 the performance of an application 712 that is running on the computing device 702. As part of monitoring 802 the performance of the application 712, the supplemental power manager 710 may determine 804 whether the application 112 is principally limited by the performance of a particular hardware component, such as the CPU 716, GPU 718, or memory 720. For example, the supplemental power manager 710 may determine whether the application 712 is CPU bound, GPU bound, or memory bound.

If the supplemental power manager 710 determines 804 that the application 712 is not principally limited by the performance of any particular hardware component, then the method 800 returns to the point where the supplemental power manager 710 monitors 802 the performance of the application 712.

If the supplemental power manager 710 determines 804 that the application 712 is principally limited by the performance of the CPU 716 (or, in other words, that the application 712 is CPU bound), then the supplemental power manager 710 may determine 806 whether additional power could improve the performance of the CPU 716. If the supplemental power manager 710 determines 806 that additional power would not improve the performance of the CPU 716, then the method 800 returns to the point where the supplemental power manager 710 monitors 802 the performance of the application 712.

If the supplemental power manager 710 determines 806 that additional power would improve (or would be likely to improve) the performance of the CPU 716, then the supplemental power manager 710 may determine 808 whether the operating power that is being supplied by the primary power source 704 of the computing device 702 is at its maximum level. If the supplemental power manager 710 determines 808 that the operating power that is being supplied by the primary power source 704 of the computing device 702 is not at its maximum level, then the method 800 may return to the point where the supplemental power manager 710 monitors 802 the performance of the application 712.

If the supplemental power manager 710 determines 808 that the operating power that is being supplied by the primary power source 704 of the computing device 702 is at its maximum level, then the supplemental power manager 710 may cause 810 the supplemental power source 706 to provide supplemental power to the computing device 702. In addition, the supplemental power manager 710 may prevent 812 the supplemental power from reaching components in the computing device 702 other than the CPU 716. In some embodiments, preventing 812 the supplemental power from reaching components in the computing device 702 other than the CPU 716 may involve sending one or more signals to power regulators in the computing device 702, such as the GPU power regulator 736b and the memory power regulator 736c. For example, the supplemental power manager 710 may activate the GPU power regulator 736b and the memory power regulator 736c so that the amount of power that is provided to the GPU 718 and the memory 720 does not change once the supplemental power source 706 starts providing supplemental power to the computing device 702.

If the supplemental power manager 710 determines 804 that the application 712 is principally limited by the performance of the GPU 718 (or, in other words, that the application 712 is GPU bound), then the supplemental power manager 710 may determine 814 whether additional power could improve the performance of the GPU 718. If the supplemental power manager 710 determines 814 that additional power would not improve the performance of the GPU 718, then the method 800 returns to the point where the supplemental power manager 710 monitors 802 the performance of the application 712.

If the supplemental power manager 710 determines 814 that additional power would improve (or would be likely to improve) the performance of the GPU 718, then the supplemental power manager 710 may determine 816 whether the operating power that is being supplied by the primary power source 704 of the computing device 702 is at its maximum level. If not, then the method 800 may return to the point where the supplemental power manager 710 monitors 802 the performance of the application 712.

If the supplemental power manager 710 determines 816 that the operating power that is being supplied by the primary power source 704 of the computing device 702 is at its maximum level, then the supplemental power manager 710 may cause 818 the supplemental power source 706 to provide supplemental power to the computing device 702. In addition, the supplemental power manager 710 may prevent 820 the supplemental power from reaching components in the computing device 702 other than the GPU 718. In some embodiments, preventing 820 the supplemental power from reaching components in the computing device 702 other than the GPU 718 may involve sending one or more signals to power regulators in the computing device 702, such as the CPU power regulator 736a and the memory power regulator 736c. For example, the supplemental power manager 710 may activate the CPU power regulator 736a and the memory power regulator 736c so that the amount of power that is provided to the CPU 716 and the memory 720 does not change once the supplemental power source 706 starts providing supplemental power to the computing device 702.

If the supplemental power manager 710 determines 804 that the application 712 is principally limited by the performance of the memory 720 (or, in other words, that the application 712 is memory bound), then the supplemental power manager 710 may determine 822 whether additional power could improve the performance of the memory 720. If the supplemental power manager 710 determines 822 that additional power would not improve the performance of the memory 720, then the method 800 returns to the point where the supplemental power manager 710 monitors 802 the performance of the application 712.

If the supplemental power manager 710 determines 822 that additional power would improve (or would be likely to improve) the performance of the memory 720, then the supplemental power manager 710 may determine 824 whether the operating power that is being supplied by the primary power source 704 of the computing device 702 is at its maximum level. If not, then the method 800 may return to the point where the supplemental power manager 710 monitors 802 the performance of the application 712.

If the supplemental power manager 710 determines 824 that the operating power that is being supplied by the primary power source 704 of the computing device 702 is at its maximum level, then the supplemental power manager 710 may cause 826 the supplemental power source 706 to provide supplemental power to the computing device 702. In addition, the supplemental power manager 710 may prevent 828 the supplemental power from reaching components in the computing device 702 other than the memory 720. In some embodiments, preventing 828 the supplemental power from reaching components in the computing device 702 other than the memory 720 may involve sending one or more signals to power regulators in the computing device 702, such as the CPU power regulator 736a and the GPU power regulator 736b. For example, the supplemental power manager 710 may activate the CPU power regulator 736a and the GPU power regulator 736b so that the amount of power that is provided to the CPU 716 and the GPU 718 does not change once the supplemental power source 706 starts providing supplemental power to the computing device 702.

For purposes of example, the method 800 shown in FIG. 8 includes specific actions that may be taken if the supplemental power manager 710 determines 804 that the application 712 is principally limited by the performance of the CPU 716, GPU 718, or memory 720. Similar actions may be taken if the supplemental power manager 310 determines 804 that the application 712 is principally limited by the performance of another hardware component, such as an SSD, FPGA, or ASIC.

As indicated above, in some embodiments a supplemental power source may be a rechargeable battery. If the battery is frequently being used to provide supplemental power, the battery may need to be recharged more frequently than it otherwise would. To help provide the energy for recharging the battery, computing devices that utilize the techniques disclosed herein may include one or more energy harvesting mechanisms. In some embodiments, the energy harvesting mechanisms may include one or more microelectromechanical systems (MEMS)-based energy harvesting mechanisms.

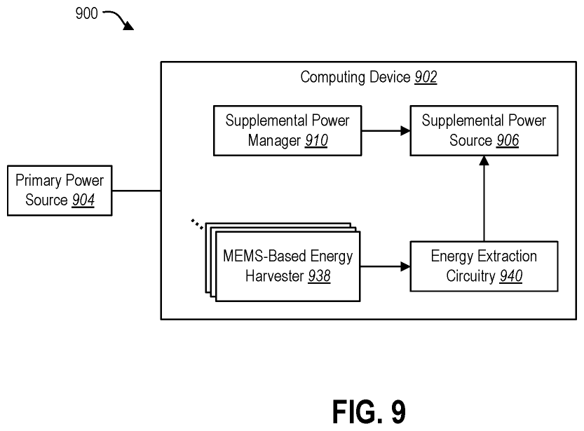

FIG. 9 illustrates an example of a system 900 that includes a supplemental power manager 910 as well as a plurality of MEMS-based energy harvesters 938. The supplemental power manager 910 may invoke supplemental power from a supplemental power source 906 under certain circumstances, as disclosed herein. The supplemental power source 906 may be a replenishable power source, such as a rechargeable battery. To replenish the supplemental power source 906 after it has been used to provide supplemental power, the MEMS-based energy harvesters 938 may be utilized to harvest energy from the computing device 902. As an example, the energy may be harvested from the heat that is generated by the components within the computing device 902. The energy that is harvested by the MEMS-based energy harvesters 938 may be used to replenish (e.g., recharge) the supplemental power source 906. For example, the computing device 902 may include energy extraction circuitry 940 that extracts the harvested energy from the MEMS-based energy harvesters 938 and supplies the harvested energy to the supplemental power source 906.

The default (or primary) mechanism for replenishing the supplemental power source 906 may be the primary power source 904 itself. The MEMS-based energy harvesters 938 may be used as a supplemental (or secondary) mechanism for replenishing the supplemental power source 906.

In some embodiments, in order to cause a supplemental power source to start providing supplemental power to a computing device, a supplemental power manager may activate a switch that couples the supplemental power source to another component within the computing device.

Another scenario in which the supplemental power manager may invoke supplemental power from the supplemental power source will now be described. As indicated above, the maximum power level for a server may be defined based on the power ratings of the components in the data center's power supply system. Generally speaking, the components within a data center's power supply system are designed so that their power ratings are higher (usually significantly higher) than the amount of power that is expected to be used by servers during actual operation, including during periods of peak power consumption where power spikes may occur. In other words, there is a margin (usually a fairly significant margin) between the maximum power level that is defined for a server in a data center (which is based on the power ratings of the components within the data center's power supply system) and the expected power consumption of the server, including peak usage. With the techniques disclosed herein, however, it may not be necessary to have such a large margin. For example, the components within a data center's power supply system may be designed so that their power ratings are high enough to accommodate most of the servers' expected power consumption, but not necessarily high enough to accommodate power spikes that may occur during peak power consumption. Supplemental power from a supplemental power source may then be used to provide power during those periods of time when power spikes occur and the power consumption of a server exceeds the maximum power level that has been defined for the server.

In embodiments where a data center's power supply system is designed for a lower threshold and a supplemental power source is used to handle power spikes, a supplemental power manager may be configured to invoke supplemental power from the supplemental power source whenever it determines that the power usage of a server is above a threshold level. The threshold level may correspond to a maximum power level that has been defined for the server.

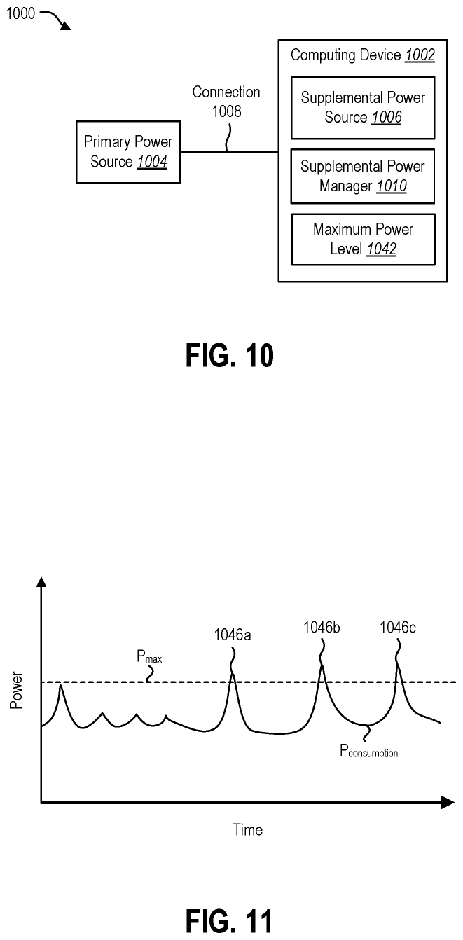

FIG. 10 illustrates an example of a system 1000 in which a maximum power level 1042 has been defined for a computing device 1002. In addition to a connection 1008 to a primary power source 1004, the computing device 1002 includes a supplemental power manager 1010 that is configured to invoke supplemental power from a supplemental power source 1006 whenever it determines that the power usage of the computing device 1002 is above the defined maximum power level 1042. In some embodiments, the computing device 1002 may be a server in a data center, and the defined maximum power level 1042 may be based on the power ratings of the components within the data center's power supply system.

FIG. 11 illustrates an example showing a defined maximum power level 1042 for the computing device 1002 (shown as Pₘₐₓ) compared to the power consumption of the computing device 1002 (shown as P_{consumption}) over time. As can be seen, the defined maximum power level 1042 may be set high enough to accommodate most of the expected power consumption of the computing device 1002, but not necessarily high enough to accommodate power spikes that may occur during peak power consumption. In the depicted example, there are three periods of time 1046a-c when P_{consumption}>Pₘₐₓ (i.e., when the power consumption of the computing device 1002 exceeds the maximum power level 1042 that has been defined for the computing device 1002). Supplemental power from the supplemental power source 1006 may be used to provide additional power to the computing device 1002 during those periods of time 1046a-c.

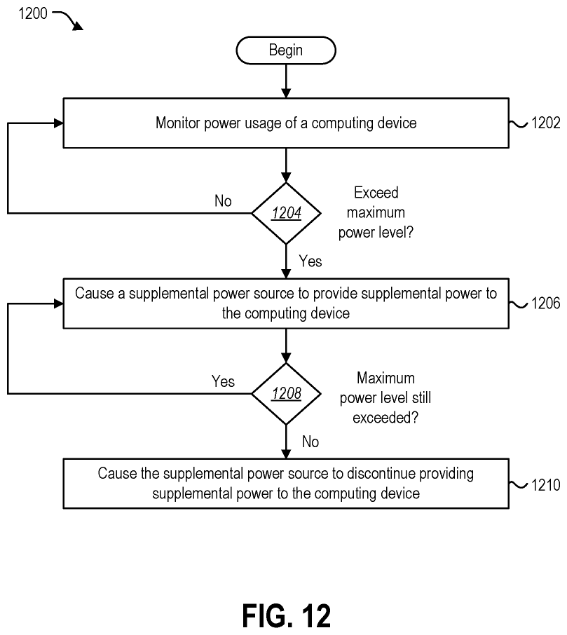

FIG. 12 illustrates an example of a method 1200 that may be implemented by the supplemental power manager 1010 in the computing device 1002 shown in FIG. 10. In accordance with the method 1200, the supplemental power manager 1010 may monitor 1202 the power usage of the computing device 1002. As part of monitoring 1202 the power usage of the computing device 1002, the supplemental power manager 1010 may determine 1204 whether the power usage of the computing device 1002 exceeds the maximum power level 1042 that has been defined for the computing device 1002.

If the supplemental power manager 1010 determines 1204 that the power usage of the computing device 1002 does not exceed the maximum power level 1042 that has been defined for the computing device 1002, then the supplemental power manager 1010 continues to monitor 1202 the power usage of the computing device 1002.

If at some point the supplemental power manager 1010 determines 1204 that the power usage of the computing device 1002 exceeds the maximum power level 1042 that has been defined for the computing device 1002, then the supplemental power manager 1010 causes 1206 the supplemental power source 1006 to provide supplemental power to the computing device 1002. The supplemental power source 1006 may continue to provide supplemental power to the computing device 1002 until the supplemental power manager 1010 determines 1208 that the power usage of the computing device 1002 no longer exceeds the maximum power level 1042, at which point the supplemental power manager 1010 may cause 1210 the supplemental power source 1006 to discontinue providing supplemental power to the computing device 1002.

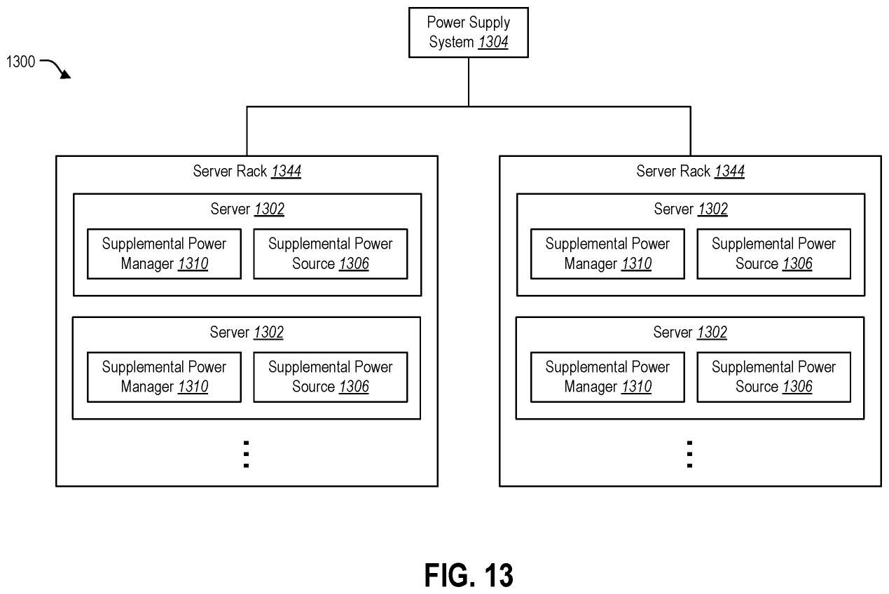

As discussed above, the techniques disclosed herein may be utilized by servers within a data center. A data center typically includes a large number of servers, which may be placed in racks. FIG. 13 illustrates a plurality of server racks 1344 within a data center 1300. Each of the server racks 1344 includes a plurality of servers 1302. Power is provided to the server racks 1344 by a power supply system 1304 of the data center 1300.

In the depicted example, each server 1302 includes a supplemental power source 1306 and a supplemental power manager 1310. In an alternative embodiment, there may be a single supplemental power source 1306 and/or a single supplemental power manager 1310 for a plurality of servers 1302. For example, in some embodiments, there may be a single supplemental power source 1306 and/or a single supplemental power manager 1310 for an entire server rack 1344.

In some embodiments, the techniques disclosed herein may be utilized by high-performance computing devices, such as servers in a data center of a cloud computing system. High-performance computing devices may be used for a wide range of computationally intensive tasks in various fields, and therefore can draw significant amounts of power.

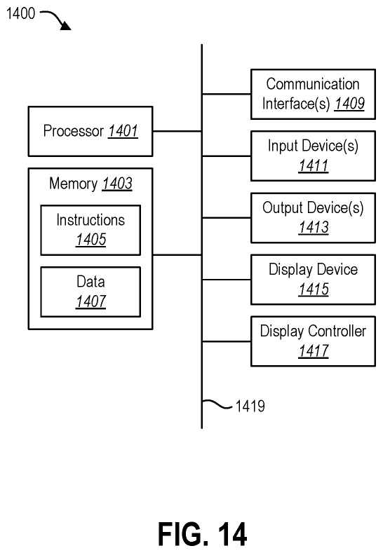

FIG. 14 illustrates certain components that may be included within a computing device 1400. The computing device 1400 includes a processor 1401. The processor 1401 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1401 may be referred to as a central processing unit (CPU). Although just a single processor 1401 is shown in the computing device 1400 of FIG. 14, in an alternative configuration, a combination of processors (e.g., an ARM and DSP) could be used.

The computing device 1400 also includes memory 1403 in electronic communication with the processor 1401. The memory 1403 may be any electronic component capable of storing electronic information. For example, the memory 1403 may be embodied as random access memory (RAM), read-only memory (ROM), magnetic disk storage media, optical storage media, flash memory devices in RAM, on-board memory included with the processor 1401, erasable programmable read-only memory (EPROM), electrically erasable programmable read-only memory (EEPROM) memory, registers, and so forth, including combinations thereof.

Instructions 1405 and data 1407 may be stored in the memory 1403. The instructions 1405 may be executable by the processor 1401 to implement some or all of the methods, steps, operations, actions, or other functionality that is disclosed herein. Executing the instructions 1405 may involve the use of the data 1407 that is stored in the memory 1403. Unless otherwise specified, any of the various examples of modules and components described herein may be implemented, partially or wholly, as instructions 1405 stored in memory 1403 and executed by the processor 1401. Any of the various examples of data described herein may be among the data 1407 that is stored in memory 1403 and used during execution of the instructions 1405 by the processor 1401.

The computing device 1400 may also include one or more communication interfaces 1409 for communicating with other electronic devices. The communication interface(s) 1409 may be based on wired communication technology, wireless communication technology, or both. Some examples of communication interfaces 1409 include a Universal Serial Bus (USB), an Ethernet adapter, a wireless adapter that operates in accordance with an Institute of Electrical and Electronics Engineers (IEEE) 1402.11 wireless communication protocol, a Bluetooth® wireless communication adapter, and an infrared (IR) communication port.

A computing device 1400 may also include one or more input devices 1411 and one or more output devices 1413. Some examples of input devices 1411 include a keyboard, mouse, microphone, remote control device, button, joystick, trackball, touchpad, and lightpen. One specific type of output device 1413 that is typically included in a computing device 1400 is a display device 1415. Display devices 1415 used with embodiments disclosed herein may utilize any suitable image projection technology, such as liquid crystal display (LCD), light-emitting diode (LED), gas plasma, electroluminescence, or the like. A display controller 1417 may also be provided, for converting data 1407 stored in the memory 1403 into text, graphics, and/or moving images (as appropriate) shown on the display device 1415. The computing device 1400 may also include other types of output devices 1413, such as a speaker, a printer, etc.

The various components of the computing device 1400 may be coupled together by one or more buses, which may include a power bus, a control signal bus, a status signal bus, a data bus, etc. For the sake of clarity, the various buses are illustrated in FIG. 14 as a bus system 1419.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory computer-readable medium having computer-executable instructions stored thereon that, when executed by at least one processor, perform some or all of the steps, operations, actions, or other functionality disclosed herein. The instructions may be organized into routines, programs, objects, components, data structures, etc., which may perform particular tasks and/or implement particular data types, and which may be combined or distributed as desired in various embodiments.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

In an example, the term “determining” (and grammatical variants thereof) encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A computer-implemented method, comprising:
identifying an application running on a computing device that can benefit from additional power;
determining that operating power that is being supplied to the computing device by a primary power source is at a maximum power level; and
causing a supplemental power source to provide supplemental power to the computing device, wherein the supplemental power is provided in addition to the operating power that is supplied by the primary power source.

2. The method of claim 1, wherein:
the computing device comprises a server in a data center; and
the primary power source comprises a power supply system of the data center.

3. The method of claim 1, wherein identifying the application that can benefit from the additional power comprises:
determining that performance of the application is principally limited by a hardware component of the computing device; and
determining that the supplemental power could improve a performance level of the hardware component.

4. The method of claim 3, wherein the hardware component is selected from the group consisting of a central processing unit (CPU), a graphics processing unit (GPU), memory, a solid-state drive (SSD), a field programmable gate array (FPGA), and an application specific integrated circuit (ASIC).

5. The method of claim 1, further comprising causing the supplemental power to be directed to a specific hardware component within the computing device.

6. The method of claim 5, wherein causing the supplemental power to be directed to the specific hardware component comprises causing a power threshold associated with the specific hardware component to be increased.

7. The method of claim 1, further comprising preventing the supplemental power from being utilized by components in the computing device other than an intended hardware component.

8. The method of claim 1, further comprising causing the supplemental power to be directed to a cooling fan within the computing device.

9. The method of claim 1, further comprising causing the supplemental power source to discontinue providing the supplemental power to the computing device in response to determining that the application can no longer benefit from the supplemental power.

10. The method of claim 1, further comprising:
saving a history of state variables corresponding to periods of time when the supplemental power is used; and
predicting when the supplemental power is beneficial based on the history.

11. A computing device comprising:
a connection to a primary power source;
a supplemental power source;
one or more processors;
memory in electronic communication with the one or more processors; and
instructions stored in the memory, the instructions being executable by the one or more processors to:
identify an application running on the computing device whose performance is principally limited by a hardware component of the computing device;
determine that additional power could improve a performance level of the hardware component;
determine that operating power that is being supplied to the computing device by the primary power source is at a maximum power level; and
cause the supplemental power source to provide supplemental power to the computing device, wherein the supplemental power is provided in addition to the operating power that is supplied by the primary power source.

12. The computing device of claim 11, wherein the supplemental power source is selected from the group consisting of a rechargeable battery and a supercapacitor.

13. The computing device of claim 11, further comprising additional instructions that are executable by the one or more processors to cause the supplemental power to be directed to a specific hardware component within the computing device.

14. The computing device of claim 13, wherein causing the supplemental power to be directed to the specific hardware component comprises causing a power threshold associated with the specific hardware component to be increased.

15. The computing device of claim 11, further comprising additional instructions that are executable by the one or more processors to cause the supplemental power to be directed to a cooling fan within the computing device.

16. The computing device of claim 11, further comprising additional instructions that are executable by the one or more processors to cause the supplemental power source to discontinue providing the supplemental power to the computing device in response to determining that the performance of the application is no longer principally limited by the hardware component or that the performance level of the hardware component is at a maximum performance level.

17. The computing device of claim 11, further comprising:
one or more microelectromechanical systems (MEMS)-based energy harvesters; and
circuitry that extracts energy from the MEMS-based energy harvesters and provides the energy to the supplemental power source.

18. A computer-readable medium comprising instructions that are executable by one or more processors to cause a computing device to:
monitor power usage of the computing device, wherein a primary power source supplies operating power to the computing device;
detect that the power usage of the computing device is above a maximum power level that has been defined for the computing device based on capabilities of the primary power source; and
cause a supplemental power source to provide supplemental power to the computing device, wherein the supplemental power is provided in addition to the operating power that is supplied by the primary power source.

19. The computer-readable medium of claim 18, wherein:
the computing device comprises a server in a data center; and
the primary power source comprises a power supply system of the data center.

20. The computer-readable medium of claim 18, further comprising additional instructions that are executable by the one or more processors to cause the supplemental power source to discontinue providing the supplemental power to the computing device in response to determining that the power usage of the computing device has fallen below the maximum power level that has been defined for the computing device.
